(19) United States
(12) Patent Application Publication
(10) Pub. No.: US 2026/0104330 A1
(43) Pub. Date: Apr. 16, 2026

(54) LEUKEMIA CELL SEPARATION AND EXTRACTION DEVICE

(71) Applicant: TONGJI HOSPITAL AFFILIATED TO TONGJI MEDICAL COLLEGE OF HUAZHONG UNIV. OF SCI. & TECH., WUHAN (CN)

(72) Inventor: YI XIAO, WUHAN (CN)

(73) Assignee: TONGJI HOSPITAL AFFILIATED TO TONGJI MEDICAL COLLEGE OF HUAZHONG UNIV. OF SCI. & TECH., WUHAN (CN)

(21) Appl. No.: 18/914,057

(22) Filed: Oct. 12, 2024

(51) Int. Cl. G01N 1/34

(52) U.S. Cl. CPC G01N 1/34

(57) ABSTRACT

The present invention discloses a leukemia cell separation and extraction device, comprising a sampling tube and a filtration assembly. Top end of inner wall of sampling tube is equipped with multiple limit blocks, while filtration assembly includes a retaining ring installed at top opening of the sampling tube, with one side contacting the limit blocks. The bottom end of inner wall of retaining ring is connected to an air duct via multiple connecting plates, with membranes between each plate. Main drainage rods, inclined and circumferentially arranged, connect the air duct's outer wall to the retaining ring's inner wall, with zigzag secondary drainage rods between them. One end of the retaining ring is attached to a push plate, and a collecting assembly is mounted on the air duct. This configuration allows for efficient plasma extraction from blood samples, retaining blood cells in the original container and enhancing separation efficiency.

### TECHNICAL FIELD

The present invention relates to the field of blood cell separation technology, and more specifically, to a leukemia cell separation and extraction device.

### BACKGROUND

Leukemia is a malignant clonal disease originating from hematopoietic stem cells, in which uncontrolled proliferation of related cells occurs in the bone marrow and other hematopoietic tissues, leading to suppression of normal hematopoiesis and infiltration into other organs. When conducting routine blood tests on leukemia patients, blood cells are typically examined to assess the condition.

However, in current methods, the separation of blood cells often involves centrifuging a blood sample after it has been allowed to settle and then using a dropper to collect layers sequentially. This process is usually time-consuming and requires repeated dropper operations by laboratory personnel. Additionally, errors in separating the blood cells from the plasma can easily occur, which reduces the effectiveness of the device.

### SUMMARY

The present invention provides a leukemia cell separation and extraction device to address the issues in existing techniques, where blood cell separation is often time-consuming and requires repeated dropper operations. Errors in separating blood cells and plasma can occur, which reduces the effectiveness of the device.

To achieve the above objectives, the present invention provides the following technical solution:

A leukemia cell separation and extraction device, including a sampling tube and a filtration assembly. The top end of the inner wall of the sampling tube is provided with multiple limit blocks, and the filtration assembly includes a retaining ring installed at the top opening of the sampling tube, with one side of the retaining ring in contact with the limit blocks. The bottom end of the inner wall of the retaining ring is equipped with an air duct connected by multiple connecting plates, with membranes connected between each connecting plate. The air duct's outer wall is connected to the inner wall of the retaining ring by multiple main drainage rods arranged circumferentially. Each main drainage rod is inclined, and multiple secondary drainage rods are arranged between adjacent main drainage rods. The secondary drainage rods are configured in a zigzag pattern, and one end of the retaining ring is connected to a push plate. The air duct is equipped with a collecting assembly.

Preferably, the collecting assembly includes a spiral guide plate mounted on the outer wall of the air duct, with the spiral guide plate oriented toward the retaining ring. The top end of the outer wall of the air duct is connected to a collecting tray, and one end of the collecting tray is provided with a drainage outlet.

Preferably, the top end of the air duct is connected to a valve body, with a spherical plug rotatably connected inside the valve body. The outer wall of the spherical plug is fixedly connected to a rotating plate, which is rotatably engaged with the outer wall of the valve body.

Preferably, the top end of the outer wall of the sampling tube is provided with a limiting assembly, which includes a rotating ring installed on the outer wall of the sampling tube. Multiple guide rods are arranged circumferentially at the top end of the rotating ring, and the top end of the sampling tube is equipped with fixed rods equal in number to the guide rods. A limiting frame is rotatably mounted on the fixed rods via a pair of arc-shaped plates, with the guide rods engaged in the limiting frame, and the bottom surface of the limiting frame flush with the top surface of the retaining ring.

Preferably, a sliding seat is mounted on the outer wall of the sampling tube, with a positioning assembly located between the sliding seat and the sampling tube. The positioning assembly includes a friction pad located near the sampling tube inside the sliding seat, a pressure plate threaded onto the outside of the sliding seat, and a knob coaxially connected to the outside of the pressure plate.

Preferably, one end of the knob is in pressing contact with the friction pad. The outer wall of the sliding seat is symmetrically provided with a pair of fixing columns, with each free end connected to a pair of clamping blocks. A leg is rotatably mounted on the fixing column, with a spring located between the leg and the sliding seat, connected to the sliding seat. The free end of the spring contacts the outer wall of the sliding seat, and multiple crossbars are arranged on the leg.

### Principles and Advantages of this Technical Solution:

(1) The filtration assembly in this invention can be used in conjunction with the collecting assembly to extract plasma from blood samples, helping laboratory personnel quickly filter out plasma while retaining the blood cell sample in the original container. To maintain plasma extraction efficiency while preventing splashing as the plasma drips down from a height, the outer wall of the air duct is connected to the inner wall of the retaining ring by multiple main drainage rods arranged circumferentially. Each main drainage rod is inclined, allowing plasma to flow along the main drainage rods to the outer wall of the air duct and then gradually to the spiral guide plate, where it is eventually guided into the collecting tray and drained through the outlet into a collection container.

(2) The limiting assembly can lock the position of the retaining ring to prevent it from falling off when the sampling tube is inverted. When using the limiting assembly, rotating the rotating ring on the outer wall of the sampling tube causes the guide rods on the rotating ring to drive the limiting frame to rotate along the fixed rods at the top end of the sampling tube until the limiting frame reaches the top of the retaining ring. To remove the retaining ring, the rotating ring can be turned in the opposite direction to disengage the limiting frame from the top of the retaining ring.

(3) The positioning assembly can lock the vertical position of the sliding seat on the sampling tube, and adjusting the legs allows the height of the sampling tube to be changed between normal and inverted states to accommodate different usage scenarios.

### BRIEF DESCRIPTION OF THE DRAWINGS

FIG. 1 is a schematic diagram of the overall structure of the present invention;

FIG. 2 is an exploded view of the present invention;

FIG. 3 is an enlarged view of area A in FIG. 2;

FIG. 4 is an enlarged view of area B in FIG. 2;

FIG. 5 is an enlarged view of area C in FIG. 2.

FIG. 6 is a schematic view of the according to another embodiment.

Reference numerals in the accompanying drawings: 1, sampling tube; 2, sliding seat; 3, spherical plug; 4, rotating plate; 5, crossbar; 6, leg; 7, valve body; 8, collecting tray; 9, spiral guide plate; 10, air duct; 11, push plate; 12, membrane; 13, retaining ring; 14, drainage outlet; 15, main drainage rod; 16, secondary drainage rod; 17, connecting plate; 18, arc-shaped plate; 19, limiting frame; 20, fixed rod; 21, limit block; 22, guide rod; 23, rotating ring; 24, clamping block; 25, fixing column; 26, friction pad; 27, pressure plate; 28, knob; 29, spring, 30, flow regulation mechanism.

### DETAILED DESCRIPTION

The present invention is described in detail below in conjunction with the drawings and embodiments:

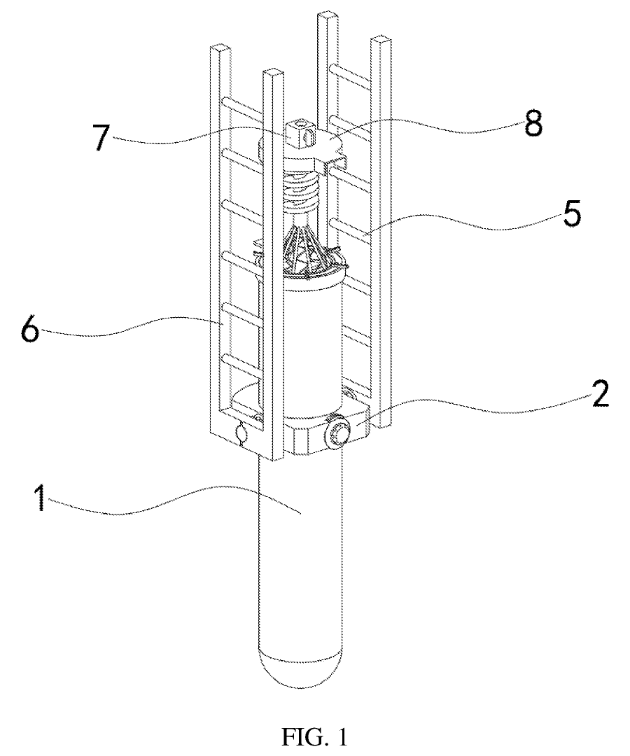

In the embodiment shown in FIGS. 1-5, the present invention provides a leukemia cell separation and extraction device, which includes a sampling tube (1) and a filtration assembly. The top end of the inner wall of the sampling tube (1) is provided with multiple limit blocks (21). The filtration assembly includes a retaining ring (13) installed at the top opening of the sampling tube (1), with one side of the retaining ring (13) in contact with the limit blocks (21). The bottom end of the inner wall of the retaining ring (13) is equipped with an air duct (10) connected by multiple connecting plates (17), with membranes (12) connected between each connecting plate (17). The air duct's (10) outer wall is connected to the inner wall of the retaining ring (13) by multiple main drainage rods (15) arranged circumferentially. Each main drainage rod (15) is inclined, with multiple secondary drainage rods (16) arranged between adjacent main drainage rods (15). The secondary drainage rods (16) are configured in a zigzag pattern. One end of the retaining ring (13) is connected to a push plate (11), and the air duct (10) is equipped with a collecting assembly.

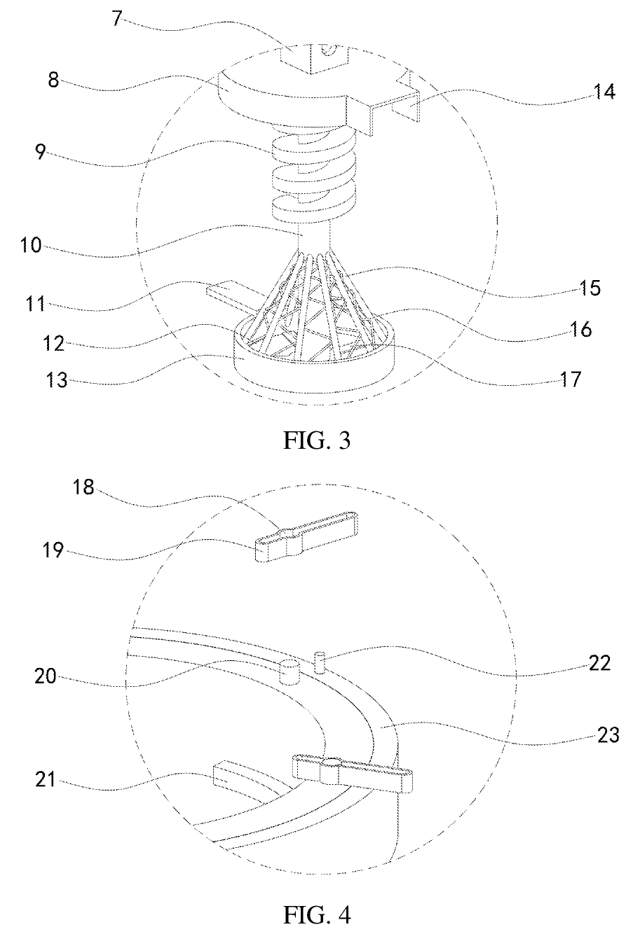

As shown in FIG. 3, the collecting assembly includes a spiral guide plate (9) mounted on the outer wall of the air duct (10), with the spiral guide plate (9) oriented toward the retaining ring (13). The top end of the outer wall of the air duct (10) is connected to a collecting tray (8), with one end of the collecting tray (8) provided with a drainage outlet (14).

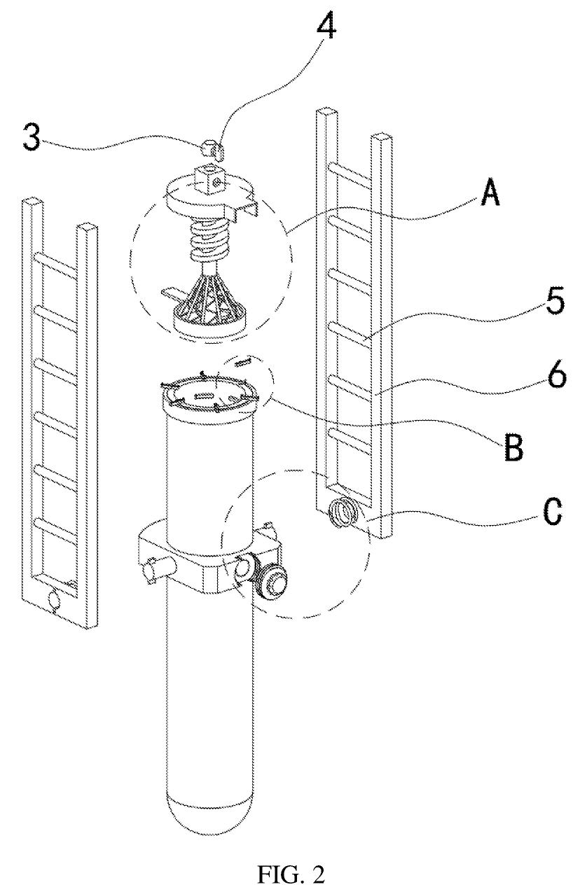

As shown in FIGS. 2 and 3, the top end of the air duct (10) is connected to a valve body (7), with a spherical plug (3) rotatably connected inside the valve body (7). The outer wall of the spherical plug (3) is fixedly connected to a rotating plate (4), which is rotatably engaged with the outer wall of the valve body (7).

As shown in FIGS. 1 and 4, the top end of the outer wall of the sampling tube (1) is provided with a limiting assembly, which includes a rotating ring (23) installed on the outer wall of the sampling tube (1). Multiple guide rods (22) are arranged circumferentially at the top end of the rotating ring (23), and the top end of the sampling tube (1) is equipped with fixed rods (20) equal in number to the guide rods (22). A limiting frame (19) is rotatably mounted on the fixed rods (20) via a pair of arc-shaped plates (18), with the guide rods (22) engaged in the limiting frame (19), and the bottom surface of the limiting frame (19) flush with the top surface of the retaining ring (13).

The limiting assembly can lock the position of the retaining ring (13) to prevent it from falling off when the sampling tube (1) is inverted. When using the limiting assembly, rotating the rotating ring (23) on the outer wall of the sampling tube (1) causes the guide rods (22) on the rotating ring (23) to drive the limiting frame (19) to rotate along the fixed rods (20) at the top end of the sampling tube (1) until the limiting frame (19) reaches the top of the retaining ring (13). To remove the retaining ring (13), the rotating ring (23) can be turned in the opposite direction to disengage the limiting frame (19) from the top of the retaining ring (13).

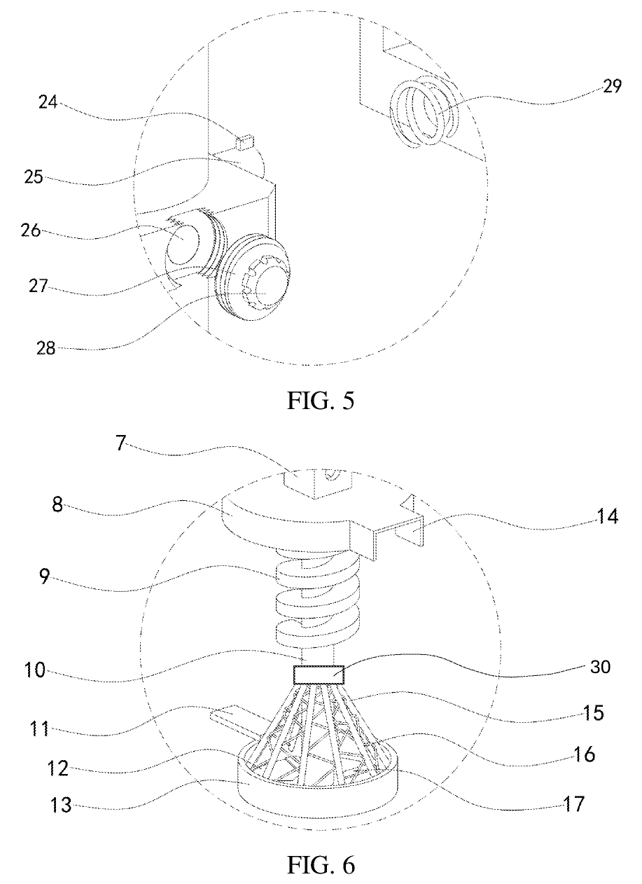

As shown in FIGS. 1 and 5, a sliding seat (2) is mounted on the outer wall of the sampling tube (1), with a positioning assembly located between the sliding seat (2) and the sampling tube (1). The positioning assembly includes a friction pad (26) located near the sampling tube (1) inside the sliding seat (2), a pressure plate (27) threaded onto the outside of the sliding seat (2), and a knob (28) coaxially connected to the outside of the pressure plate (27).

As shown in FIGS. 2 and 5, one end of the knob (28) is in pressing contact with the friction pad (26). The outer wall of the sliding seat (2) is symmetrically provided with a pair of fixing columns (25), with each free end connected to a pair of clamping blocks (24). A leg (6) is rotatably mounted on the fixing column (25), with a spring (29) located between the leg (6) and the sliding seat (2), connected to the sliding seat (2). The free end of the spring (29) contacts the outer wall of the sliding seat (2), and multiple crossbars (5) are arranged on the leg (6).

The positioning assembly can lock the vertical position of the sliding seat (2) on the sampling tube (1), and adjusting the legs (6) allows the height of the sampling tube (1) to be changed between normal and inverted states to accommodate different usage scenarios. To adjust the position of the sliding seat (2), the knob (28) is rotated to move the pressure plate (27) outward, causing the friction pad (26) to stop contacting the outer wall of the sampling tube (1). The sliding seat (2) can then be moved along the sampling tube (1) to adjust its position.

When inverting the sampling tube (1), the legs (6) need to be adjusted simultaneously. Press the legs (6) inward until they disengage from the clamping blocks (24), compressing the springs. Rotate the legs (6) 180 degrees so that the clamping blocks (24) on the fixing columns (25) switch positions. Release the legs (6), and they will return to their original positions under the force of the springs, locking the current position.

### Specific Use and Functions of the Embodiment:

The filtration assembly in this invention can be used with the collecting assembly to extract plasma from blood samples, aiding laboratory personnel in quickly filtering out plasma while retaining the blood cell sample in the original container. When using this device for blood cell extraction, first adjust the valve body (7) at the top end of the air duct (10) to the open position, then snap the retaining ring (13) into the top of the sampling tube (1), ensuring contact between the bottom end of the retaining ring (13) and the top surface of the limit blocks (21) inside the sampling tube (1). Adjust the limiting assembly to lock the position between the retaining ring (13) and the sampling tube (1). Next, connect a pressure pump to one end of the valve body (7) and maintain the pressure at one atmosphere. Adjust the positions of the legs (6) and sliding seat (2) to keep the sampling tube (1) inverted. The blood sample will then come into contact with the membrane (12) connected via the connecting plates (17) on the retaining ring (13). Place a container for collecting plasma at one end of the drainage outlet (14), and pressurize the inside of the sample tube using the pressure pump. The plasma in the blood sample will pass through the membrane (12) under the influence of gravity and air pressure. To maintain the efficiency of plasma extraction while avoiding splashes when the plasma falls to the liquid surface, the drained plasma will flow onto the secondary drainage rods (16) or main drainage rods (15). The plasma on the secondary drainage rods (16) will gradually flow onto the main drainage rods (15), which are arranged in a zigzag pattern. The plasma will then flow along the outer wall of the air duct (10), eventually reaching the spiral guide plate (9), and finally be guided into the collecting tray (8) and drained into a collection container through the drainage outlet (14).

Referring to FIG. 6, to further improve the efficiency and precision of plasma separation, the device is designed with a flow regulation mechanism (30) at the junction between the air duct (1) and the drainage rods (15, 16). This mechanism includes adjustable flow restrictors that can fine-tune the rate of plasma flow through the drainage rods (15, 16), ensuring consistent filtration under various sample volumes and viscosities. The flow restrictors can be manually or automatically adjusted based on real-time feedback from flow sensors integrated into the drainage system. Additionally, the spiral guide plate features micro-textured surfaces to facilitate laminar flow, reducing turbulence as the plasma enters the collecting tray. The combination of adjustable flow control and optimized surface design prevents disruptions in plasma flow, enhances the smoothness of the drainage process, and ensures that the blood cell sample remains undisturbed within the original container.

The above description is only an embodiment of the present invention. Known specific technical solutions and/or characteristics in the field have not been extensively described. It should be noted that modifications and improvements can be made by those skilled in the art without departing from the technical solution of the present invention, and such modifications should be considered within the scope of protection of the present invention. The protection scope of this application should be defined by the content of its claims, and the embodiments described in the specification can be used to interpret the claims.

What is claimed is:

1. A leukemia cell separation and extraction device, characterized in that comprising: a sampling tube and a filtration assembly, wherein the top end of the inner wall of the sampling tube is provided with multiple limit blocks, and the filtration assembly includes a retaining ring installed at the top opening of the sampling tube, with one side of the retaining ring in contact with the limit blocks, the bottom end of the inner wall of the retaining ring is equipped with an air duct connected by multiple connecting plates, with membranes connected between each connecting plate, and the outer wall of the air duct is connected to the inner wall of the retaining ring by multiple main drainage rods arranged circumferentially, each main drainage rod is inclined, and multiple secondary drainage rods are arranged between adjacent main drainage rods in a zigzag pattern, one end of the retaining ring is connected to a push plate, and the air duct is equipped with a collecting assembly.

2. The leukemia cell separation and extraction device according to claim 1, characterized in that the collecting assembly includes a spiral guide plate mounted on the outer wall of the air duct, with the spiral guide plate oriented toward the retaining ring, and the top end of the outer wall of the air duct is connected to a collecting tray, with one end of the collecting tray provided with a drainage outlet.

3. The leukemia cell separation and extraction device according to claim 2, characterized in that the top end of the air duct is connected to a valve body, with a spherical plug rotatably connected inside the valve body, the outer wall of the spherical plug is fixedly connected to a rotating plate, which is rotatably engaged with the outer wall of the valve body.

4. The leukemia cell separation and extraction device according to claim 3, characterized in that the top end of the outer wall of the sampling tube is provided with a limiting assembly, which includes a rotating ring installed on the outer wall of the sampling tube, with multiple guide rods arranged circumferentially at the top end of the rotating ring, and the top end of the sampling tube is equipped with fixed rods equal in number to the guide rods, a limiting frame is rotatably mounted on the fixed rods via a pair of arc-shaped plates, with the guide rods engaged in the limiting frame, and the bottom surface of the limiting frame is flush with the top surface of the retaining ring.

5. The leukemia cell separation and extraction device according to claim 4, characterized in that a sliding seat is mounted on the outer wall of the sampling tube, with a positioning assembly located between the sliding seat and the sampling tube, the positioning assembly includes a friction pad located near the sampling tube inside the sliding seat, a pressure plate threaded onto the outside of the sliding seat, and a knob coaxially connected to the outside of the pressure plate.

6. The leukemia cell separation and extraction device according to claim 5, characterized in that one end of the knob is in pressing contact with the friction pad, the outer wall of the sliding seat is symmetrically provided with a pair of fixing columns, with each free end connected to a pair of clamping blocks, a leg is rotatably mounted on the fixing column, a spring is located between the leg and the sliding seat and connected to the sliding seat, with the free end of the spring contacting the outer wall of the sliding seat, and multiple crossbars are arranged on the leg.

7. The leukemia cell separation and extraction device according to claim 6, characterized in that the junction between the air duct and the drainage rods is equipped with adjustable flow restrictors to regulate the plasma flow rate, allowing consistent filtration across different sample volumes and viscosities.

8. The leukemia cell separation and extraction device according to claim 7, characterized in that the adjustable flow restrictors are configured to be manually or automatically adjusted based on real-time data from flow sensors integrated into the drainage system.

9. The leukemia cell separation and extraction device according to claim 8, characterized in that the spiral guide plate is provided with a micro-textured surface to facilitate laminar flow of the plasma, reducing turbulence and enhancing the smoothness of the drainage process as plasma enters the collecting tray.
